(19) United States
(12) Patent Application Publication
(10) Pub. No.: US 2008/0030177 A1
(43) Pub. Date: Feb. 7, 2008

(54) SOFT-START CIRCUIT OF LINEAR VOLTAGE REGULATOR AND METHOD THEREOF

(76) Inventors: Hung-I Chen, Kao-Hsiung City (TW); Chih-Hong Lou, Yilan County (TW)

Correspondence Address: NORTH AMERICA INTELLECTUAL PROPERTY CORPORATION, P.O. BOX 506, MERRIFIELD, VA, 22116, US

(21) Appl. No.: 11/461,765

(22) Filed: Aug. 1, 2006

(51) Int. Cl. G05F 1/00

(52) U.S. Cl. 323/282

(57) ABSTRACT

A voltage regulator circuit for providing a substantially constant output voltage is disclosed. The voltage regulator circuit has a voltage regulator, a current sensing and comparing circuit, a capacitive load circuit, and a control circuit. The voltage regulator generates an output current in response to a control signal to provide the output voltage. The current sensing and comparing circuit senses the output current and outputs a result signal according to a sensed output current and a predetermined current value. The control circuit generates the control signal according to the comparison result to limit the output current. The capacitive load circuit provides the control circuit with a first capacitance when the voltage regulator circuit changes from a first mode to a second mode and provides the control circuit with a second capacitance when the voltage regulator circuit changes from the second mode to the first mode.

### BACKGROUND

The present disclosure relates to voltage regulation, and more particularly, to a voltage regulator circuit and a method of operating the voltage regulator circuit.

Please refer to FIG. 1. FIG. 1 shows a circuit diagram of a linear voltage regulator circuit 100 according to the related art. As shown in FIG. 1, the linear voltage regulator circuit 100 comprises a linear voltage regulator 102 and a current sensing and limiting circuit 104. The linear voltage regulator circuit 100 is for providing a constant output voltage Vₒᵤₜ according to an input voltage Vᵢₙ. The constant output voltage Vₒᵤₜ serves as a reference voltage for external circuits represented by a capacitor Cₑₓₜ and a resistor R_{load}. The linear voltage regulator 102, including a control module 108, a pass transistor Mₓ, and two resistors R₁₁, R₁₂, is used to regulate an output voltage Vₒᵤₜ. The functionality of the control module 108, which can be implemented by a low drop out (LDO) control circuit, is controlled by an enabling signal EN. A voltage regulating function is performed when, for example, EN is logic low.

As to the current sensing and limiting circuit 104, it includes a plurality of transistors M₁₁-M₁₆, where the transistor M₁₂ is biased by a bias voltage V_{bias} and the on/off status of the transistor M₁₃ is controlled by the aforementioned enabling signal EN. The configuration of the transistors M₁₁-M₁₂ acts as a current sensing and comparing circuit for monitoring whether the output current Iₒᵤₜ exceeds a current limit, while the configuration of the transistors M₁₃-M₁₆ serves as a control circuit for tuning the voltage V₁ for over-current protection. Please note that, since the operations of the linear voltage regulator 102 and current sensing and limiting circuit 104 are well known to those skilled in this art, a detailed description is omitted for the sake of brevity.

When the linear voltage regulator 102 is turned on by the control module 108, the transistor M₁₃ is turned off to make the current sensing and limiting circuit 104 active. In addition, the pass transistor Mₓ is turned on to pass an output current Iₒᵤₜ for establishing the output voltage Vₒᵤₜ through a voltage divider built by the resistors R₁₁, R₁₂. However, when the output current Iₒᵤₜ exceeds its current limit, the current sensing and limiting circuit 104 will detect that the sensed output current exceeds a predetermined current value Iₗᵢₘᵢₜ, and then proceed to lower the output current Iₒᵤₜ by adjusting the voltage V₁ fed into the gate of the pass transistor Mₓ. Therefore, the configuration of the current sensing and limiting circuit 104 is able to maintain the output current Iₒᵤₜ at a highest acceptable current value.

Once the enabling signal EN transits from logic low to logic high, both the linear voltage regulator 102 and current sensing and limiting circuit 104 are disabled. In other words, because the linear voltage regulator circuit 100 is turned off, the output voltage Vₒᵤₜ is lowered to 0V. Next, when the linear voltage regulator circuit 100 starts up (i.e., enabling signal EN becomes logic low), a voltage value at node A is pulled down through transistor M₁₂ of the current sensing and limiting circuit 104. In the beginning, the current sensing and limiting circuit 104 is unable to function immediately in response to the output current Iₒᵤₜ. In addition, the pass transistor Mₓ is working in a linear region, resulting in a large charging current passing through the pass transistor Mₓ to the capacitor Cₑₓₜ. This charging current could cause unpredictable damage to other circuits coupled to the linear voltage regulator circuit 100 or to the linear voltage regulator circuit 100 itself if there exists a current return path.

### SUMMARY

It is therefore one of the objectives of the present disclosure to provide a voltage regulator circuit and a method of operating the voltage regulator circuit, to solve the above problem.

According to an embodiment of the present disclosure, a voltage regulator circuit for providing a substantially constant output voltage is disclosed. The voltage regulator circuit has: a voltage regulator for generating an output current in response to a control signal to provide the output voltage, a current sensing and comparing circuit, coupled to the regulator, for sensing the output current and outputting a result signal according to a sensed output current and a predetermined current value, a control circuit, coupled to the current sensing and comparing circuit, for generating the control signal according to the result signal to limit the output current, and a capacitive load circuit, coupled to the current sensing and comparing circuit and the control circuit, for providing the control circuit with a first capacitance when the circuit changes from a first mode to a second mode and for providing the control circuit with a second capacitance when the circuit changes from the second mode to the first mode.

According to an embodiment of the present disclosure, a method for providing a substantially constant output voltage is disclosed. The method comprises: generating an output current in response to a control signal to regulate the output voltage; sensing the output current and outputting a comparison result at an output port according to a sensed output current and a predetermined current value; generating the control signal according to the result signal to limit the output current; and providing the output port with a first capacitance when changes from a first mode to a second mode and providing the output port with a second capacitance when changes from the second mode to the first mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram of a linear voltage regulator circuit according to the related art.

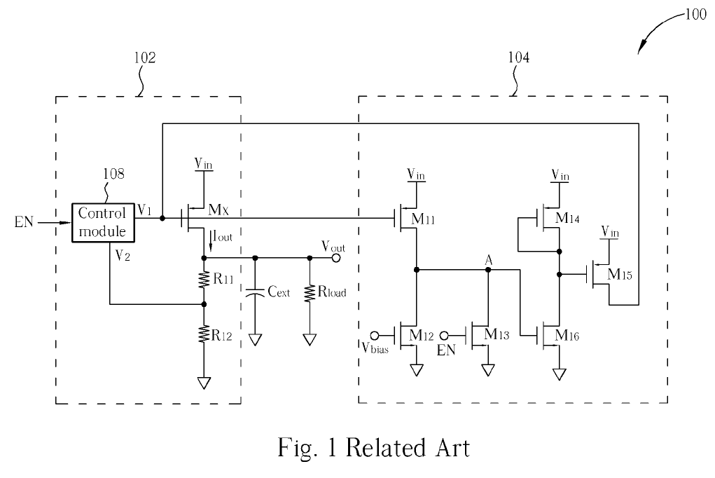

FIG. 2 is a block diagram of a soft-start linear voltage regulator circuit.

FIG. 3 is a circuit diagram of a soft-start linear voltage regulator circuit according to an embodiment of the present disclosure.

### DETAILED DESCRIPTION

Certain terms are used throughout the following description and claims to refer to particular system components. As one skilled in the art will appreciate, manufacturers may refer to a component by different names. In the following discussion and in the claims, the terms “include” and “comprise” are used in an open-ended fashion. Also, the term “couple” is intended to mean either an indirect or direct electrical connection. Thus, if a first device is coupled to a second device, that connection may be through a direct electrical connection, or through an indirect electrical connection via other devices and connections.

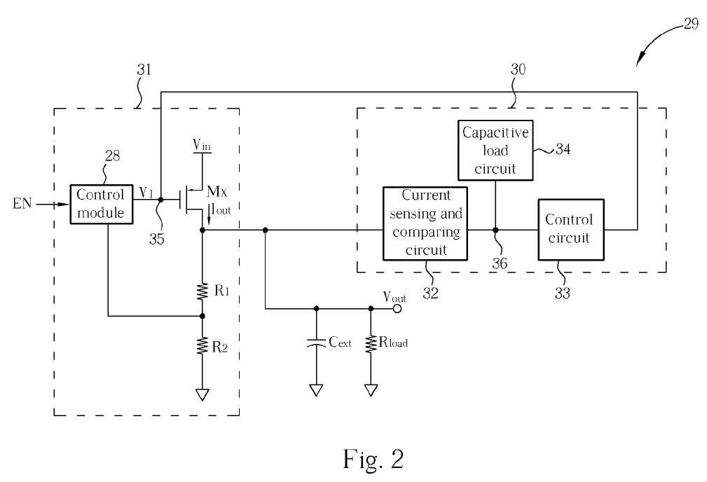

FIG. 2 shows a block diagram of a soft-start linear voltage regulator circuit 29. With reference to FIG. 2, the soft-start linear voltage regulator circuit 29 comprises a linear voltage regulator 31 and a current sensing and limiting circuit 30. When the output current Iₒᵤₜ exceeds a predetermined current value, the current sensing and comparing circuit 32 senses Iₒᵤₜ and accordingly outputs a voltage, which can be thought of as a result signal, at node 36. In response to the voltage at node 36, the control circuit 33 automatically adjusts the voltage, which can be thought of as a control signal, at node 35. Thus, the gate voltage of Mₓ is adjusted to decrease Iₒᵤₜ.

The soft-start linear voltage regulator circuit 29 has a first mode and a second mode. For example, the first mode can be thought of as a current-limiting mode while the second mode be thought of as a normal mode. The capacitive load circuit 34 is an “asynchronous” capacitive load. More specifically, when the soft-start linear voltage regulator circuit 29 changes from the current-limiting mode to the normal mode, the capacitive load circuit 34 provides a a large capacitive load to node 36. When the soft-start linear voltage regulator circuit 29 changes from the normal mode to the current-limiting mode, the capacitive load circuit 34 provides a small capacitive load to node 36. When the soft-start linear voltage regulator circuit 29 is turned off, i.e., the soft-start linear voltage regulator circuit 29 does not provide the voltage regulating function, the capacitive load circuit 34 pulls high the voltage at node 36, so that the soft-start linear voltage regulator circuit 29 enters, or approaches, the current-limiting mode.

When the soft-start linear voltage regulator circuit 29 is initially started up, Iₒᵤₜ is limited because the soft-start linear voltage regulator circuit 29 is in, or close to, the current-limiting mode. At this time, the soft-start linear voltage regulator circuit 29 changes slowly from the current-limiting mode to the normal mode by gradually changing the voltage at node 36, resulting in a slowly increased Iₒᵤₜ.

In a normal operation, when over-current occurs, the voltage at node 36 causes the soft-start linear voltage regulator circuit 29 to change from the normal mode to the current-limiting mode. The response time of over-current protection will not be affected because the capacitive load circuit 34 is now a small capacitive load.

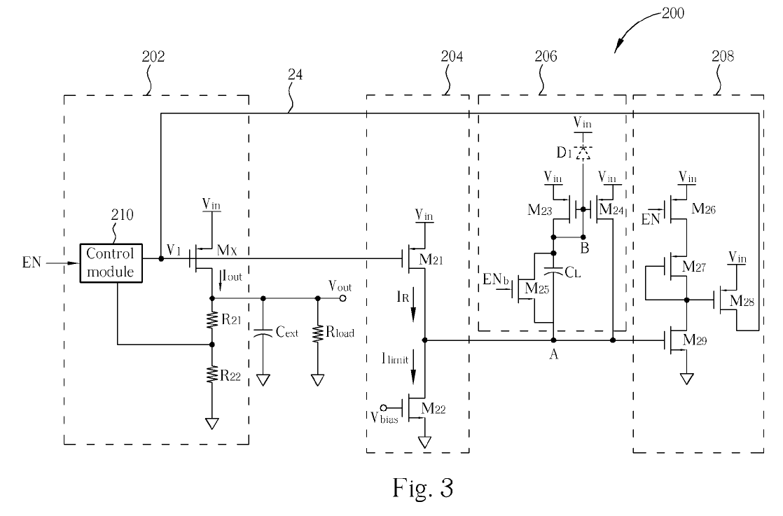

Please refer to FIG. 3. FIG. 3 is a circuit diagram of a soft-start linear voltage regulator circuit 200 according to an embodiment of the present disclosure. As shown in FIG. 3, the soft-start linear voltage regulator circuit 200 comprises a linear voltage regulator 202, a current sensing and comparing circuit 204, a capacitive load circuit 206, and a control circuit 208. The combination of the current sensing and comparing circuit 204, the capacitive load circuit 206, and control circuit 208 acts as a current sensing and limiting circuit and the capacitive load circuit 206 offers a “soft-start” mechanism. Like the related art linear voltage regulator circuit 100, the soft-start linear voltage regulator circuit 200 provides a constant output voltage Vₒᵤₜ according to an input voltage Vᵢₙ, where the constant output voltage Vₒᵤₜ serves as a reference voltage for external circuits represented by a capacitor Cₑₓₜ and a resistor R_{load}. However, compared with the related art linear voltage regulator circuit 100, the soft-start linear voltage regulator circuit 200 activates a soft-start mechanism to generate a slowly increasing output current Iₒᵤₜ instead of an instant large output current Iₒᵤₜ when starting up. Greater detail is provided later.

In this embodiment, the linear voltage regulator 202, including a control module 210, a pass transistor Mₓ, and resistors R₂₁, R₂₂, is used to regulate the output voltage Vₒᵤₜ. The functionality of the control module 210, which can be implemented by a low drop out (LDO) control circuit, is controlled by an enabling signal EN. A voltage regulating function is performed when, for example, EN is logic low.

As to the current sensing and comparing circuit 204, it includes a plurality of transistors M₂₁-M₂₂. It should be noted that the transistor M₂₂ is biased by a bias voltage V_{bias}. The current sensing and comparing circuit 204 is capable of sensing the output current Iₒᵤₜ to obtain a sensed output current I_{R} and monitoring whether the sensed output current I_{R} exceeds a predetermined current value Iₗᵢₘᵢₜ. That is, the current sensing and comparing circuit 204 senses the output current Iₒᵤₜ and outputs a result signal according to the sensed output current I_{R} and the predetermined current value Iₗᵢₘᵢₜ. If the sensed output current I_{R} exceeds the predetermined current value Iₗᵢₘᵢₜ, it implies that the output current Iₒᵤₜ exceeds a desired current limit. In this embodiment, the biased transistor M₂₂ serves as a current source for defining the predetermined current value Iₗᵢₘᵢₜ. Additionally, the sensed output current I_{R} passing through the current mirror path where the transistor M₂₂ is located is designed to be less than the actual output current Iₒᵤₜ. The result signal, which represents a comparison result between the sensed output current I_{R} and the predetermined current value Iₗᵢₘᵢₜ, is presented at node A to control the voltage level thereof. However, this is merely provided as an example. Assume the same current sensing and comparing function is implemented; other circuit designs are possible for the current sensing and comparing circuit 204.

The control circuit 208 includes a plurality of transistors M₂₆-M₂₉, where the on/off status of the transistor M₂₆ is controlled by the enabling signal EN. The control circuit 208 is utilized to tune the voltage V₁ according to the result signal given by the current sensing and comparing circuit 204.

The key difference between the soft-start linear voltage regulator circuit 200 and the related art linear voltage regulator circuit 100 is the inclusion of the capacitive load circuit 206. As shown in FIG. 3, the capacitive load circuit 206 includes a current mirror implemented by transistors M₂₃, M₂₄, a capacitive load C_{L}, and a switch implemented by a transistor M₂₅, where the on/off status of the transistor M₂₅ is controlled by an enabling signal EN_{b} whose logic level is opposite to that of the enabling signal EN. In this embodiment, the capacitive load circuit 206 is utilized to provide an asymmetric capacitive load, and is further detailed below.

The current sensing and limiting circuit, implemented by the current sensing and comparing circuit 204, the capacitive load circuit 206, and control circuit 208, ensures the output current Iₒᵤₜ is within a predetermined level. More specifically, when the sensed output current I_{R} exceeds the predetermined current value Iₗᵢₘᵢₜ, the current sensing and limiting circuit will lower the output current Iₒᵤₜ to keep the sensed output current I_{R} at a highest acceptable value, said Iₗᵢₘᵢₜ. In this embodiment, when the enabling signal EN is logic low, the soft-start linear voltage regulator circuit 200 works normally for voltage-regulating purposes. Please note that the enabling signal EN_{b} is logic high accordingly. On the other hand, once the enabling signal EN becomes logic high, the soft-start linear voltage regulator circuit 200 is turned off, and then the output voltage Vₒᵤₜ is lowered to 0V. In addition, the voltage level at node A is pulled up to approach the input voltage Vᵢₙ.

Next, when the soft-start linear voltage regulator circuit 200 starts up, the voltage level at node A is pulled down from its original level approximately equal to the input voltage Vᵢₙ. The voltage level at node B is decreased as the voltage level at node A is decreased due to the activated transistor M₂₂. Once the decreasing voltage level at node B causes the transistors M₂₃, M₂₄ to be turned on, the capacitance viewed by node A is magnified. In the capacitive load circuit 206, the aspect ratio (W/L) of the transistor M₂₃ and the aspect ratio of the transistor M₂₄ are K1 and K2, where K2/K1=K (K>1). In other words, a current mirror ratio of a second current mirror path corresponding to the transistor M₂₄ to a first current mirror path corresponding to the transistor M₂₃ is K. Therefore, the equivalent capacitive load viewed by node A is substantially equal to (1+K)*C_{L}. In this embodiment, K is significantly greater than one. The equivalent capacitive load viewed by node A, therefore, is substantially equal to K*C_{L}. Please note that the capacitive load C_{L} has small capacitance such that the chip area for implementing the capacitive load circuit 206 is small. However, with the specific configuration shown in FIG. 3, the capacitive load circuit 206 is able to produce a capacitive load of large capacitance K*C_{L}.

The voltage level at node A is slowly decreased because of the large capacitance K*C_{L}. In other words, the voltage level at node A is slowly pulled down. The transistor M₂₉ is gradually turned off, leading to a gradually increasing gate voltage of the transistor M₂₈ and a slowly decreasing voltage V1. Therefore, the output current Iₒᵤₜ passing through the pass transistor Mₓ increases slowly until it becomes stable. This prevents an instant large current from causing unpredictable damage to the soft-start linear voltage regulator circuit 200 or other circuits coupled to the soft-start linear voltage regulator circuit 200.

Furthermore, when the enabling signal EN is logic low, the soft-start linear regulator 200 is able to work normally for voltage regulating purposes. In this embodiment, as the sensed output current I_{R} exceeds the predetermined current value Iₗᵢₘᵢₜ, the voltage level at node A is pushed up due to the current I_{R} over the predetermined current value limit. The transistors M₂₃, and M₂₄ are turned off when the voltage level at node A is rising. At this time, since the transistor M₂₅ is turned off, the node B is equivalent to a floating end. Therefore, the capacitive load C_{L} has no effect on the voltage level at node A. Later, when the voltage level at node B is sufficiently high, the diode D₁ is forward biased to connect node B and the input voltage Vᵢₙ. Because the capacitive load C_{L} has small capacitance, it will not affect the response speed of tuning the output current Iₒᵤₜ. In short, at a start-up of the linear voltage regulator circuit 200, the capacitive load 206 can obtain the objective of slowly pushing up the output current Iₒᵤₜ. This is called “soft-start”.

After reading the above disclosure, a person skilled in this art can easily understand that other circuit designs can be applied to implement the linear voltage regulator 202, the current sensing and comparing circuit 204, the capacitive load circuit 206, and the control circuit 208. That is, the circuit configuration shown in FIG. 3 serves as only one embodiment of the present disclosure, and is not meant to be taken as a limitation.

Briefly summarized, the present disclosure provides a method and apparatus thereof for offering a “soft-start” mechanism. This is achieved by implementing an asymmetric capacitive load, i.e., the capacitive load circuit 206 shown in FIG. 3. The capacitive load circuit 206 of the present invention offers large capacitance when the soft-start linear voltage regulator circuit 200 starts up and offers small capacitance when the sensed output current I_{R} exceeds the predetermined current value Iₗᵢₘᵢₜ′. In other words, the capacitive load circuit 206 is able to make the linear voltage regulator 202 slowly increase the output current Iₒᵤₜ when the soft-start linear voltage regulator circuit 200 starts up. Additionally, the capacitive load circuit 206 does not affect the over-current protection applied to the output current Iₒᵤₜ.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A voltage regulator circuit, comprising:
a voltage regulator, for generating an output current in response to a control signal to regulate an output voltage; and
a current sensing and limiting circuit coupled to the voltage regulator, the current sensing and limiting circuit comprising:
a current sensing and comparing circuit, coupled to the voltage regulator, for sensing the output current and outputting a result signal at an output port according to a sensed output current and a predetermined current value;
a control circuit, coupled to the output port of the current sensing and comparing circuit and the voltage regulator, for generating the control signal according to the result signal to limit the output current; and
a capacitive load circuit, coupled to the output port of the current sensing and comparing circuit and the control circuit, for providing the output port with a first capacitance when the voltage regulator circuit changes from a first mode to a second mode, and for providing the output port with a second capacitance when the voltage regulator circuit changes from the second mode to the first mode.

2. The voltage regulator circuit of claim 1, wherein the voltage regulator circuit enters the first mode when starting up.

3. The voltage regulator circuit of claim 1, wherein the first capacitance is greater than the second capacitance.

4. The voltage regulator circuit of claim 1, wherein the capacitive load circuit comprises:
a current mirror having a first current mirror path and a second current mirror path, the current mirror being enabled when the voltage regulator circuit changes from the first mode to the second mode; and
a capacitive load positioned at the first current mirror path.

5. The voltage regulator circuit of claim 4, wherein a current mirror ratio of the second current mirror path to the first current mirror path is greater than one.

6. The voltage regulator circuit of claim 4, wherein the capacitive load circuit further comprises:
a switch, coupled to both ends of the capacitive load, the switch being turned off when the voltage regulator circuit is in the first or second mode, the switch being turned on before the voltage regulator circuit enters the first mode.

7. A current limiting method, comprising:
generating an output current in response to a control signal;
sensing the output current;
comparing a sensed output current with a predetermined current value to generate a result signal at an output port;
generating the control signal according to the result signal to limit the output current; and
providing the output port with a first capacitance when changing from a first mode to a second mode and providing the output port with a second capacitance when changing from the second mode to the first mode.

8. The method of claim 7, wherein the first mode is entered when the method starts up or when the sensed output current exceeds the predetermined current value.

9. The method of claim 7, wherein the first capacitance is greater than the second capacitance.

10. The method of claim 7, wherein the step of providing the output port with the first capacitance when changing from the first mode to the second mode and providing the output port with the second capacitance when changing from the second mode to the first mode is performed by:
providing a current mirror having a first current mirror path and a second current mirror path;
enabling the current mirror when changing from the first mode to the second mode; and
positioning a capacitive load at the first current mirror path.

11. The method of claim 10, wherein a current mirror ratio of the second current mirror path to the first current mirror path is greater than one.

12. The method of claim 10, wherein the step of providing the output port with the first capacitance when changing from the first mode to the second mode and providing the output port with the second capacitance when changing from the second mode to the first mode is further performed by:
coupling a switch between both ends of the capacitive load;
turning off the switch in the first or second mode; and
turning on the switch before entering the first mode.

13. A current sensing and limiting circuit, comprising:
a current sensing and comparing circuit for sensing an output current and accordingly outputting a result signal to a node;
a control circuit coupled to the node, for outputting a control signal in response to the result signal, the control signal being utilized to adjust the output current; and
a capacitive load circuit coupled to the node, for providing the node with a first capacitance when the current sensing and limiting circuit changes from a first mode to a second mode and for providing the node with a second capacitance when the current sensing and limiting circuit changes from the second mode to the first mode, and the first capacitance being larger than the second capacitance.

14. The current sensing and limiting circuit of claim 13, wherein the current sensing and comparing circuit senses the output current and compares a sensed output current with a predetermined current value to accordingly output the result signal.

15. The current sensing and limiting circuit of claim 13, wherein when the current sensing and limiting circuit is initially started up, the current sensing and limiting circuit is already in the first mode.

16. The current sensing and limiting circuit of claim 13, wherein the capacitive load circuit comprises:
a current mirror having a first current mirror path and a second current mirror path, the current mirror being enabled when the current sensing and limiting circuit changes from the first mode to the second mode; and
a capacitive load positioned at the first current mirror path.

17. The current sensing and limiting circuit of claim 16, wherein a current mirror ratio of the second current mirror path to the first current mirror path is greater than one.

18. The current sensing and limiting circuit of claim 16, wherein the capacitive load circuit further comprises:
a switch, coupled to both ends of the capacitive load, the switch being turned off when the current sensing and limiting circuit is in the first or second mode, and the switch being turned on before the current sensing and limiting circuit enters the first mode.
